(19) United States
(12) Patent Application Publication
(10) Pub. No.: US 2012/0235367 A1
(43) Pub. Date: Sep. 20, 2012

(54) CUTTER-TOOLING ASSEMBLY

(76) Inventor: CHIN-CHIU CHEN, TAICHUNG CITY (TW)

(21) Appl. No.: 13/046,939

(22) Filed: Mar. 14, 2011

(51) Int. Cl. B23B 31/20

(52) U.S. Cl. 279/46.1

(57) ABSTRACT

A cutter-tooling assembly has a tool holder, a positioning chunk, a cutter and a collet. The tool holder has a through hole axially formed through the tool holder. The positioning chunk is screwed in the through hole and has a cavity. The cavity has multiple corners formed around an inner surface of the cavity. The cutter is inserted into the through hole and has multiple edges abutting the corners. Because the cross sectional shape of the cavity is multilateral and has multiple corners which the edges abut, the combination of the corners and the edges can prevent a relative rotation between the tool holder and the cutter and make the cutter securely connected with the tool holder.

### BACKGROUND OF THE INVENTION

1. Field of the Invention

The present invention relates to a cutter-tooling assembly, and more particularly to a cutter-tooling assembly to prevent a relative rotation between a cutter and a tool holder.

2. Description of Related Art

A conventional cutter-tooling assembly has a tool holder, a cutter and a collet. The tool holder has a through hole axially formed through the tool holder. The cutter is inserted into the through hole. The collet is mounted in the through hole of the tool holder and is securely mounted around the cutter. Accordingly, the assembling of the tool holder and the cutter is completed and the conventional cutter-tooling assembly is ready for further operation.

However, the strength with which the collet clamps the cutter is insufficient and cross sectional shapes of the cutter and the through hole of the tool holder are round, so a relative rotation between the tool holder and the cutter may still occur and the conventional cutter-tooling assembly needs to be improved.

To overcome the shortcomings, the present invention tends to provide a cutter-tooling assembly to mitigate the aforementioned problems.

### SUMMARY OF THE INVENTION

The main objective of the invention is to provide a cutter-tooling assembly to prevent a relative rotation between a cutter and a tool holder.

A cutter-tooling assembly has a tool holder, a positioning chunk, a cutter and a collet. The tool holder has a through hole axially formed through the tool holder. The positioning chunk is screwed in the through hole and has a cavity. The cavity has multiple corners formed around an inner surface of the cavity. The cutter is inserted into the through hole and has multiple edges abutting the corners. Because the cross sectional shape of the cavity is multilateral and has multiple corners which the edges abut, the combination of the corners and the edges can prevent a relative rotation between the tool holder and the cutter and make the cutter securely connected with the tool holder.

Other objects, advantages and novel features of the invention will become more apparent from the following detailed description when taken in conjunction with the accompanying drawings.

### BRIEF DESCRIPTION OF THE DRAWINGS

FIG. 1 is a perspective view in partial section of a first embodiment of a cutter-tooling assembly in accordance with the present invention;

FIG. 2 is an exploded perspective view in partial section of the cutter-tooling assembly in FIG. 1;

FIG. 3 is a cross sectional side view of the cutter-tooling assembly in FIG. 1;

FIG. 4 is an enlarged perspective view of the cutter of the cutter-tooling assembly in FIG. 2;

FIG. 5 is an enlarged cross sectional end view of a fixing area of a cutter of a second embodiment of the cutter-tooling assembly in accordance with the present invention;

FIG. 6 is an exploded perspective view in partial section of a third embodiment of a cutter-tooling assembly in accordance with the present invention; and

FIG. 7 is an exploded perspective view in partial section of a fourth embodiment of a cutter-tooling assembly in accordance with the present invention.

### DETAILED DESCRIPTION OF PREFERRED EMBODIMENT

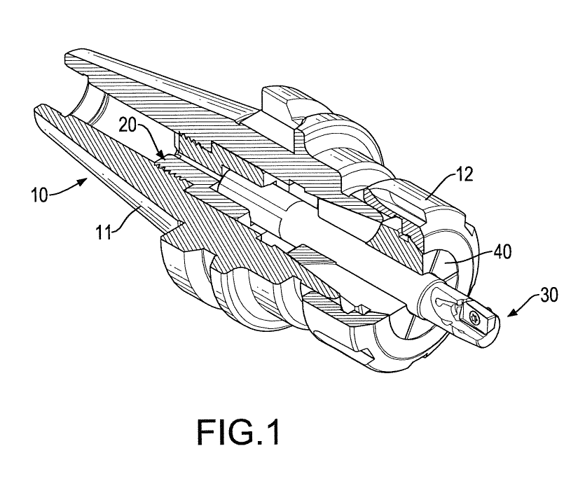

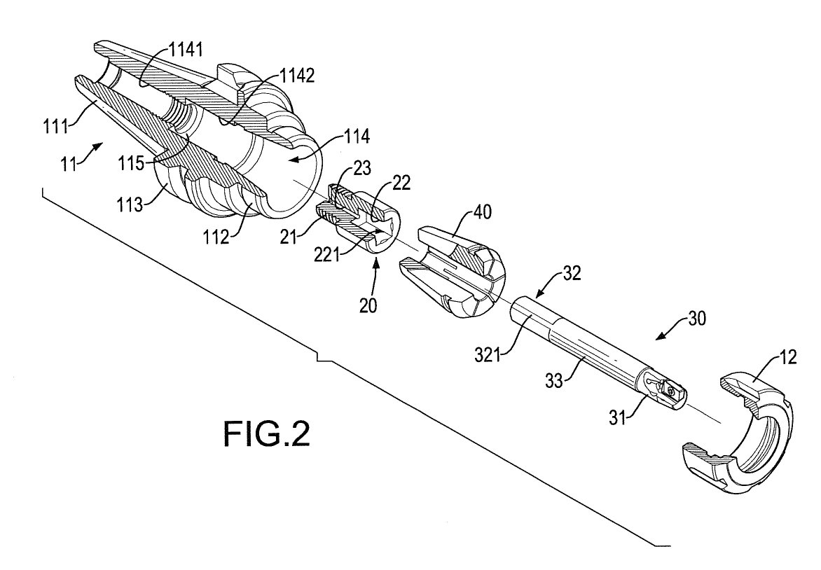

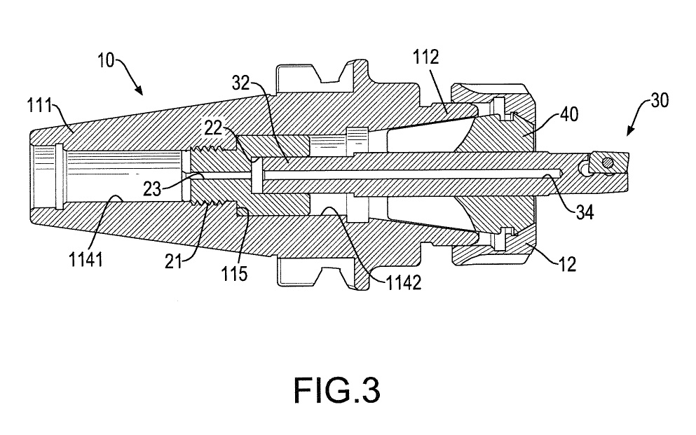

With reference to FIGS. 1 to 3, a first embodiment of a cutter-tooling assembly in accordance with the present invention comprises a tool holder 10, a positioning chunk 20, a cutter 30 and a collet 40.

The cylindrical tool holder 10 has a main body 11 and a cap 12. The main body 11 has a connecting section 111, a collet section 112, a flange section 113, a through hole 114 and an abutting surface 115. The connecting section 111 is semi-conical. The collet section 112 is opposite to the connecting section 111. The flange section 113 is located between the connecting section 111 and the collet section 112.

The through hole 114 is axially formed through the connecting section 111, the flange section 113 and the collet section 112. Preferably, the through hole 114 has a first segment 1141 and a second segment 1142. The first segment 1141 is axially formed through the connecting section 111. The second segment 1142 is axially formed though the collet section 112 and has a diameter larger than that of the first segment 1141 and a bottom.

The abutting surface 115 is annular and is formed on the bottom of the second segment 1142 of the through hole 114.

The cap 12 is mounted on a distal end of the collet section 112.

The tool holder 10 except the through hole 114 may be conventional and detailed description is omitted.

The positioning chunk 20 is mounted securely in the through hole 114 of the tool holder 10, abuts the abutting surface 115 and has a first end, a second end, an external threaded part 21 and a cavity 22.

The second end of the positioning chunk 20 is opposite to the first end of the positioning chunk 20.

The external threaded part 21 is formed around the first end of the positioning chunk 20 and is screwed in the first segment 1141 of the through hole 114.

The cavity 22 is axially formed in the second end of the positioning chunk 20 and has a non-circular cross section, an inner surface and multiple corners 221. The corners 221 are formed around the inner surface of the cavity 22 at intervals.

Preferably, the positioning chunk 20 has a coolant hole 23 axially formed through the positioning chunk 20 and communicating with the cavity 22.

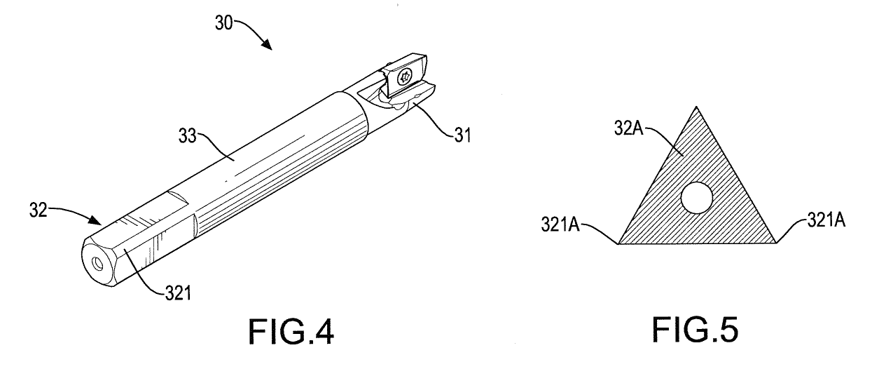

With reference to FIGS. 1 to 4, the cutter 30 is mounted securely through the cap 12, is inserted into the through hole 114 and has a cutting area 31, a fixing area 32 and a shank 33. The cutting area 31 is located outside the collet section 112.

The fixing area 32 is opposite to the cutting area 31 and has an outer surface and multiple edges 321. The edges 321 are formed on the outer surface of the fixing area 32 and abut the corners 221. Preferably, the fixing area 32 has a cross sectional shape the same as that of the cavity 22, and the edges 321 respectively abut the corners 221. The cross sectional shape of the fixing area 32 is rectangular and four edges 221 are correspondingly implemented.

The shank 33 is formed between the cutting area 31 and the fixing area 32.

Alternatively, the cross sectional shape of the fixing segment 1141 may be different from that of the fixing area 32. For example, the cross sectional shape of the fixing segment 1141 is hexagonal and the cross sectional shape of the fixing area 32 is triangular, as shown in FIG. 5. With further reference to FIG. 5, a second embodiment of the cutter-tooling assembly is substantially the same as the first embodiment except that the cross sectional shape of the fixing area 32A is triangular and three edges 321A are correspondingly implemented. Therefore, three edges 321A of the fixing area 32A abut three of the corners 221 of the fixing segment 1141 to prevent a relative rotation between the cutter 30 and the tool holder 10. The present invention does not limit the cross sectional shapes of the fixing area 32,32A and the cavity 22.

Preferably, the cutter 30 has a cutter aperture 34 formed through the cutter 30 and communicating with the cavity 22.

Accordingly, a coolant can flow through the coolant hole 23 and the cutter aperture 34 to cool the cutter 30 and a workpiece.

With reference to FIGS. 1 to 3, the collet 40 is mounted in the through hole 114 at the collet section 112 and is mounted securely around the shank 33 of the cutter 30. The collet 40 may be conventional. Detailed description and how the collet 40 clamps the shank 33 are omitted.

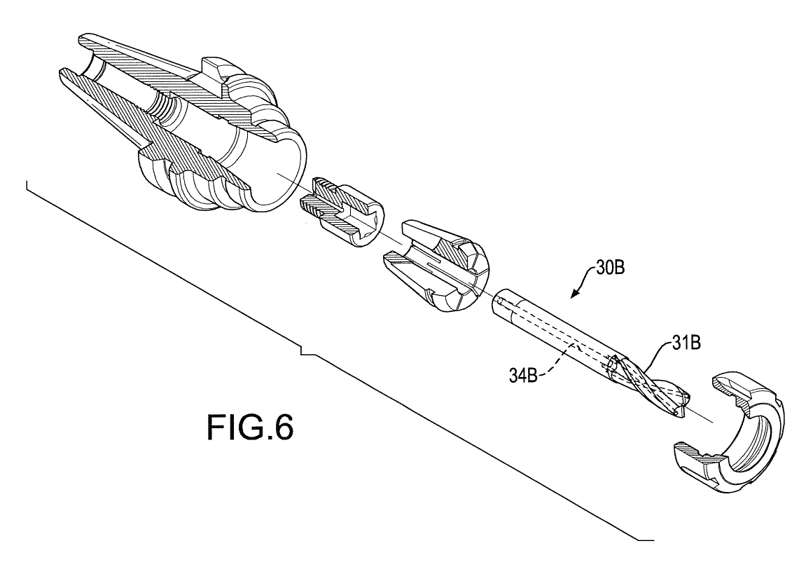

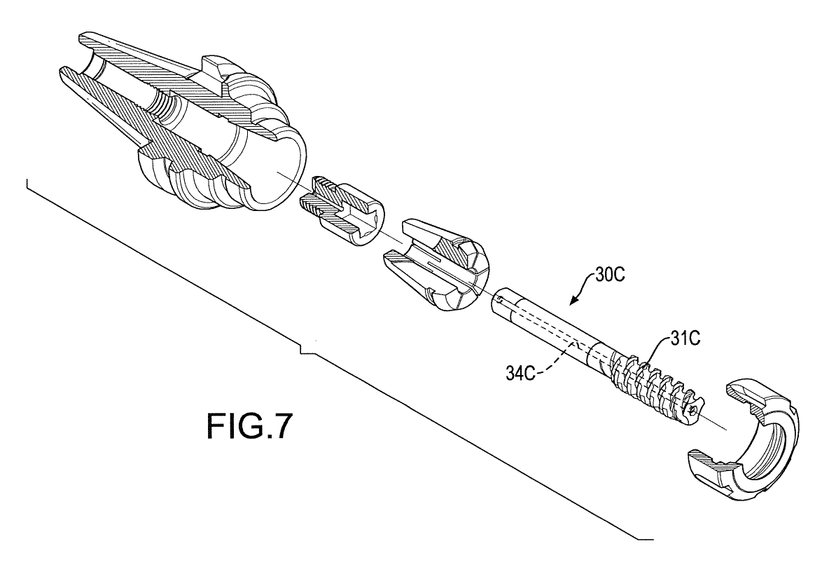

With reference to FIGS. 6 to 7, a third and a fourth embodiment of the cutter-tooling assembly are respectively the same as the first embodiment except that the cutting areas 31B, 31C of cutters 30B, 30C are different. The cutter 30B of the third embodiment is a milling cutter and the cutter 30C of the fourth embodiment is a tapping cutter. Accordingly, different cutters 30, 30B, 30C can be applied to the cutter-tooling assembly in accordance with the present invention. The cutters 30B, 30C respectively have a cutter aperture 34B, 34C.

From the above description, it is noted that the present invention has the following advantages:

1. Prevention of a relative rotation between the tool holder 10 and the cutter 30, 30B, 30C:

The cross sectional shape of the cavity 22 of the positioning chunk 20 is multilateral and has multiple corners 221 which the edges 321, 321A of the cutter 30, 30B, 30C abut, so the combination of the corners 221 and the edges 321, 321A can prevent a relative rotation between the tool holder 10 and the cutter 30, 30B, 30C and make the cutter 30, 30B, 30C securely connected with the tool holder 10.

2. Good heat dissipating effect:

Because a coolant can flow through the coolant hole 23 and the cutter aperture 34,34B,34C, the heat of the cutter 30,30B,30C and the workpiece can be cooled, a heat dissipating effect is enhanced and the lifespan of the cutter-tooling assembly in accordance with the present invention is prolonged.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cutter-tooling assembly comprising:
a cylindrical tool holder having
a connecting section;
a collet section opposite to the connecting section;
a flange section located between the connecting section and the collet section; and
a through hole formed axially through the connecting section, the flange section and the collet section;
a positioning chunk mounted securely in the through hole of the tool holder and having
a first end;
a second end opposite to the first end of the positioning chunk;
an external threaded part formed around the first end of the positioning chunk and screwed in the through hole of the tool holder; and
a cavity axially formed in the second end of the positioning chunk and having
a non-circular cross section;
an inner surface; and
multiple corners formed around the inner surface of the cavity at intervals;
a cutter inserted into the through hole of the tool holder and having
a cutting area located outside the collet section;
a fixing area being opposite to the cutting area and having an outer surface and multiple edges which are formed on the outer surface of the fixing area and abut the corners; and
a shank formed between the cutting area and the fixing area; and
a collet mounted in the through hole of the tool holder at the collet section and mounted securely around the shank of the cutter.

2. The cutter-tooling assembly as claimed in claim 1, wherein the fixing area has a cross sectional shape the same as that of the cavity; and the edges respectively abut the corners.

3. The cutter-tooling assembly as claimed in claim 2, wherein the positioning chunk has a coolant hole axially formed through the positioning chunk and communicating with the cavity.

4. The cutter-tooling assembly as claimed in claim 3, wherein the cutter has a cutter aperture formed through the cutter and communicating with the cavity.

5. The cutter-tooling assembly as claimed in claim 4, wherein
the through hole of the tool holder has
a first segment axially formed through the connecting section and screwed securely on the external threaded part; and
a second segment axially formed though the collet section and having a diameter larger than that of the first segment and a bottom; and
the tool holder has an annular abutting surface formed on the bottom of the second segment of the through hole of the tool holder and abutted by the positioning chunk.

6. The cutter-tooling assembly as claimed in claim 5, wherein
the cross sectional shape of the fixing area is rectangular and four edges are correspondingly implemented.

7. The cutter-tooling assembly as claimed in claim 5, wherein
the cross sectional shape of the fixing area is triangular and three edges are correspondingly implemented.

8. The cutter-tooling assembly as claimed in claim 1, wherein
the positioning chunk has a coolant hole axially formed through the positioning chunk and communicating with the cavity.

9. The cutter-tooling assembly as claimed in claim 1, wherein
the cutter has a cutter aperture formed through the cutter and communicating with the cavity.

10. The cutter-tooling assembly as claimed in claim 1, wherein
the through hole of the tool holder has
a first segment axially formed through the connecting section and screwed securely on the external threaded part; and
a second segment axially formed though the collet section and having a diameter larger than that of the first segment and a bottom; and
the tool holder has an annular abutting surface formed on the bottom of the second segment of the through hole of the tool holder and abutted by the positioning chunk.
